(19) United States
(12) Patent Application Publication
(10) Pub. No.: US 2008/0090105 A1
(43) Pub. Date: Apr. 17, 2008

(54) Substrate for a magnetic recording medium and magnetic recording medium using the substrate

(75) Inventor: Takashi Shimada, Matsumoto-shi (JP)

Correspondence Address: KANESAKA BERNER AND PARTNERS LLP, 1700 DIAGONAL RD, SUITE 310, ALEXANDRIA, VA, 22314-2848, US

(73) Assignee: FUJI ELECTRIC DEVICE TECHNOLOGY CO., LTD., Tokyo (JP)

(21) Appl. No.: 11/896,158

(22) Filed: Aug. 30, 2007

(30) Foreign Application Priority Data
Oct. 12, 2006 (JP) 2006-008311

(51) Int. Cl. G11B 5/64

(52) U.S. Cl. 428/826

(57) ABSTRACT

A magnetic recording medium has a disk-shaped glass substrate less than or equal to 1 inch (27.4 mm) in diameter, wherein a ratio (t²/d) of a square of the thickness t (mm) to a diameter d (mm) is greater than or equal to 0.007. A deformation of the magnetic recording medium that occurs when it is mounted in the magnetic recording device and clamped can be made small. Therefore, the flying of the magnetic head can be made stable.

### BACKGROUND OF THE INVENTION AND RELATED ART STATEMENT

The present invention relates to a substrate for a magnetic recording medium which is used in various magnetic recording devices and, more particularly, to a glass substrate for a disk-shaped magnetic recording medium. The invention also relates to a magnetic recording medium in which a magnetic recording layer is formed on such a substrate.

The deflective strength of a glass substrate for a magnetic recording medium is in proportion to the square of the thickness t and in inverse proportion to the diameter d. Relatively small disk-shaped magnetic recording mediums using a glass substrate, which are currently widely available, have four different sizes, that is, 2.5 inches, 1.89 inches, 1 inch, and 0.85 inches. In general, the diameter d and the thickness t of the glass substrates for those magnetic recording media have the following values. The ratio (t²/d) of the square of the thickness t (mm) to the diameter d (mm) is generally in a range of 0.005 to 0.007.

TABLE 1

| Diameter d | Thickness t | (t²/d) |
|---|---|---|
| 2.5 in. (65 mm) | 0.635 mm | 0.0062 |
| 1.89 in. (48 mm) | 0.508 mm | 0.0054 |
| 1 in. (27.4 mm) | 0.381 mm | 0.0053 |
| 0.85 in. (21.6 mm) | 0.381 mm | 0.0067 |

It is known, as previous results, that the deflective strength of a magnetic recording medium is sufficient if the ratio (t²/d) falls within the above range 0.005 to 0.007. Note that the notations of mm represent actual diameters, and the notations of inch are names of the products.

JP-A (Japanese Patent Application Publication Number) 2001-344742 discloses the following in connection with the diameter d and the thickness t. According to the abstract of the specification in JP-A-2001-344742, the invention of this reference is summarized as follows. The object of the invention is to “suppress resonance-induced disk flutter which occurs during rotation even in the case where a disk substrate made of a low rigidity material is used.” The means for solution is “a disk-shaped recording medium using a disk substrate whose Young's modulus is less than or equal to 7.0×10³ kgf/mm², Poison ratio is greater than or equal to 0.22, mass density is less than or equal to 2.55×10⁻¹⁰ kgf·sec²/mm⁴, and diameter is less than or equal to 3.5 inches, wherein relationships t≦0.064 dc/2−0.22 and t≧0.064 dc/2−0.58 is satisfied where t (mm) is the thickness of the disk substrate and dc (mm) is the outer diameter of a clamp for holding a central portion of the disk substrate, in the case where the flutter amplitude and the resonance frequency of a lowest-order flutter mode are less than or approximately equal to those of a disk-shaped recording medium that uses a glass substrate and is 2.5 inches in diameter and 0.635 147 mm in thickness.”

Furthermore, JP-A-2001-344742 states, in paragraph [0057], “FIG. 2 shows flutter amplitude measurement values of a 1.8-inch GA disk (using a glass substrate) whose disk outer diameter d is 48 mm and disk thickness t is 0.635 mm.” In this case, the ratio (t²/d) is calculated as 0.0084. That is, this reference discloses, in connection with the flutter amplitude, the (t²/d) value that is larger than the range 0.005 to 0.007.

Incidentally, in recent years, magnetic recording devices have been applied to a wide variety of mobile uses and have decreased in size. As the size decreases, the diameter and the thickness of the magnetic recording medium can be reduced. However, as the thickness decreases, a problem arises that the substrate is deformed due to clamping when a magnetic recording medium is mounted on the spindle of a magnetic recording device, resulting in unstable flying of the magnetic head.

The present invention has been made in view of the above circumstances in the art, and an object of the invention, which relates to a small magnetic recording medium having a glass substrate of 1 inch (27.4 mm) or less in diameter, is therefore to reduce deformation of the substrate that occurs when the magnetic recording medium is mounted on the spindle of a magnetic recording device and to thereby achieve stable flying of the magnetic head.

### SUMMARY OF THE INVENTION

To attain the above object, the invention provides a substrate for a magnetic recording medium which is a disk-shaped glass plate and is less than or equal to 1 inch (27.4 mm) in diameter d, wherein a ratio (t²/d) of the square of a thickness t (mm) to the diameter d (mm) is greater than or equal to 0.007. It is preferable that the ratio (t²/d) be greater than or equal to 0.012.

Another aspect of the invention provides a magnetic recording medium comprising the above substrate and a magnetic recording layer formed thereon.

To reduce deformation of a magnetic recording medium that occurs when it is clamped, it is important how to clamp the magnetic recording medium in such a manner that it is kept as flat as possible. However, the greatest factor in causing the deformation is the reduction in thickness. Even if the size and the thickness of the magnetic recording media are reduced, sufficient deflective strength is secured as long as the ratio (t²/d) of the square of the thickness t (mm) to the diameter d (mm) is in a range of 0.005 to 0.007. However, the deformation of a magnetic recording medium that occurs when it is clamped can be reduced by increasing the thickness.

The invention can reduce deformation of the substrate of a magnetic recording medium that occurs when the magnetic recording medium is mounted on the spindle of a magnetic recording device, and thereby enables to obtain a stable flying of the magnetic head.

### BRIEF DESCRIPTION OF THE DRAWINGS

FIG. 1 shows a flatness measurement result of a magnetic recording medium according to the present invention that was obtained in a state that it was mounted in a magnetic recording device and clamped;

FIG. 2 shows a flatness measurement result of a magnetic recording medium of Comparative Example in a state that it was mounted in the magnetic recording device and clamped; and

FIG. 3 shows a flatness measurement result of the magnetic recording medium of Comparative Example of FIG. 2 in a state that it was not clamped.

### DETAILED DESCRIPTION OF PREFERRED EMBODIMENTS

In a disk-shaped glass substrate for a magnetic recording medium whose diameter is less than or equal to 1 inch (27.4 mm), the deformation of the magnetic recording medium that occurs when it is clamped can be reduced by setting the ratio (t²/d) of the square of the thickness t (mm) to the diameter d (mm) greater than or equal to 0.007.

Example in which the flatness of a magnetic recording medium is measured and evaluated in a state that it is mounted in a magnetic recording device and clamped will be described below together with Comparative Example.

The flatness was measured by a phase shift interference type surface shape measuring instrument GPI, a product of Zygo Corporation (now Canon Marketing Japan Inc.).

### EXAMPLE

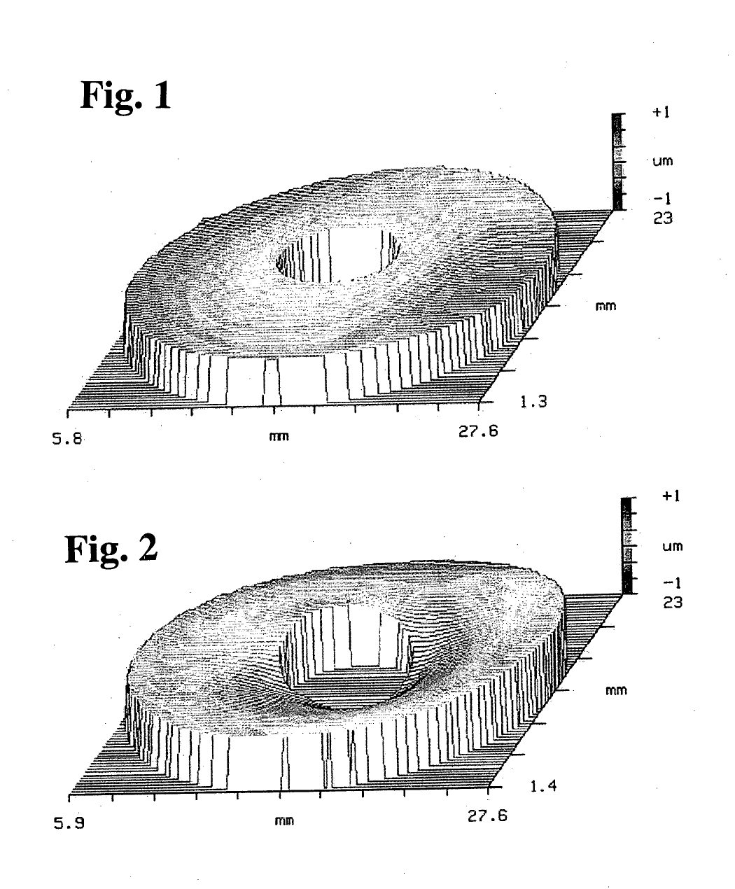

A magnetic recording medium of Example is manufactured by using a glass substrate (for a magnetic recording medium) whose diameter d was 0.85 inches (21.6 mm) and thickness t is 0.508 mm (the ratio t²/d was 0.012) and its flatness is measured. FIG. 1 shows a flatness measurement result of the magnetic recording medium that is obtained in a state that it is mounted in a magnetic recording device and clamped. The flatness is 0.37 μm in the clamped state.

### COMPARATIVE EXAMPLE

A magnetic recording medium of Comparative Example is manufactured by using a glass substrate (for a magnetic recording medium) whose diameter d is 0.85 inch (21.6 mm) and thickness t is 0.381 mm (the ratio t²/d is 0.0067) and its flatness is measured. FIG. 2 shows a flatness measurement result of the magnetic recording medium that is obtained in a state that it is mounted in the magnetic recording device and clamped. The flatness is 1.12 μm in the clamped state.

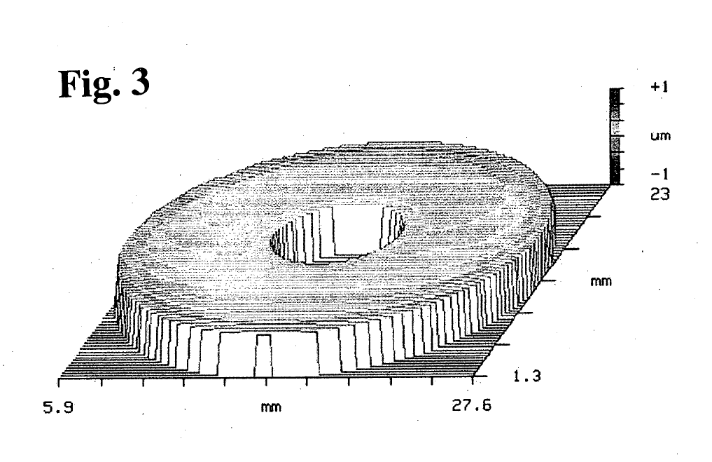

FIG. 3 shows a flatness measurement result of the magnetic recording medium of Comparative Example of FIG. 2 in a state where it is not clamped. The flatness without clamping is 0.15 μm.

As is apparent from the above results, in Example, the deformation of the magnetic recording medium that occurs when it is mounted in a magnetic recording device and clamped can be made much smaller than in Comparative Example, whereby the flying of the magnetic head can be made stable.

The disclosure as disclosed in Japanese Utility Model Application No. 2006-008311 filed on Oct. 12, 2006 is incorporated herein.

While the invention has been explained with reference to the specific embodiments of the invention, the explanation is illustrative, and the invention is limited only by appended claims.

What is claimed is:

1. A substrate for a magnetic recording medium which is a disk-shaped glass plate and is less than or equal to 27.4 mm in diameter, wherein a ratio (t²/d) of a square of a thickness t (mm) to a diameter d (mm) is greater than or equal to 0.007.

2. The substrate for a magnetic recording medium according to claim 1, wherein the ratio (t²/d) is greater than or equal to 0.012.

3. A magnetic recording medium comprising: the substrate according to claim 1, and a magnetic recording layer formed on the substrate.
